(19) United States
(12) Patent Application Publication
(10) Pub. No.: US 2002/0173985 A1
(43) Pub. Date: Nov. 21, 2002

(54) System and method for producing a business model including consolidation, distribution, and execution of business rules in a distributed network

(76) Inventors: Andrew Kent Yohn, Bolivar, MO (US); William Douglas Roller, Bolivar, MO (US); John Mark Roller, Dadeville, MO (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/150,733

(22) Filed: May 17, 2002

Related U.S. Application Data
(60) Provisional application No. 60/291,812, filed on May 17, 2001.

(51) Int. Cl. G06F 17/60

(52) U.S. Cl. 705/1; 705/7

(57) ABSTRACT

The present invention is directed to a system and method for providing distributed and consistent definition, development and deployment of rule based products throughout a distributed network environment. The development and deployment of a rule based product is accomplished through creating a manuscript to define a business product and incorporating into the manuscript, deployment and execution instructions. The manuscript provides a consistent product concept to one or more individuals or departments. The present invention further provides a central repository for the manuscript so that one or more individuals on a distributed network can collaboratively develop manuscript simultaneously.

### CROSS REFERENCE TO RELATED APPLICATIONS

This application claims priority to U.S. Serial No. 60/291,812, filed May 17, 2001, which is fully incorporated herein by reference.

### FIELD OF THE INVENTION

The present invention relates to computing network environments. More specifically, this invention relates to a system and method for consolidating the development, the distribution and the execution of business rules in a distributed network environment.

### BACKGROUND OF THE INVENTION

The current economy dictates that companies need to accelerate the development and deployment of products. Product cycles are shorter as e-commerce drives the need for companies to respond in real time to changes in consumer behavior and needs. Products that are information or rule based also tend to be subject to these requirements. The problem with such products stems from the fact that most of the information relating to the products is often dispersed throughout a company. The dispersion occurs in multiple ways, the most significant of which is the assignment of specific functions or phases of the product development cycle to multiple groups or departments. In other words, the development of a product generally requires that the product pass from department to department during its development cycle. At each stage of this cycle, it is not uncommon for different software tools that generate different file or document formats to be utilized by each of the departments, thus introducing document disparity as well as dispersion.

By way of example and not limitation, this discussion will focus on the application of this invention to the insurance industry as an example of a rule based industry. Within an insurance company or other rule-based industries, the process of taking a product from conception to distribution, in other words the product cycle, involves many departments and individuals whose input and work products are necessary for the different phases of the product cycle. FIG. 4 illustrates the steps involved in a typical product cycle. The starting point of a product cycle is the product idea. Business decisions or market demands typically initiate a product idea, shown in step 401. The details of the product must then be formatted and developed through an internal process. The nature of the insurance business requires that evaluation and approval of a product must be sought through an underwriting process, shown as step 402. The merits, potential costs, risks and methods of coverage are evaluated in a process that initiates and results in the creation of several rules, documents and files, which typically are incorporated as a part of the product. Once the underwriting process is completed, the product needs to be implemented. Implementation programming, shown in step 404, typically involves creation or changes to forms, computer programs and screens, procedures and so on. Here again, a separate set of new documents, files and procedures that will become a part of the product are generated. With the product defined and programming implementation completed, the next phase of the product cycle is the development of brochures, advertisements and other such tools to aide in the dissemination of information and the product. This task, shown in step 406, is usually performed by a marketing group. As in all the other development processes, a host files and documents and information are generated for the purpose of conveying the rules and the product to multiple audiences. The materials provided by marketing in step 406 will be distributed to various recipients, 408-412, each of these recipient users have a different level of insurance savvy. As such, marketing at step 406 has to create a variety of materials in formats that are targeted at multiple levels of audiences. For instance, the information or product that is delivered to an agent 412 may be sophisticated, with a lot of technical terms and less detailed explanations of product offerings. On the other hand, the information that goes to the consumer 410 must be presented in lay terms with lots of examples. All these aspects of product cycle that have been described create many problems for the insurance industry. For example, the lineal product cycle results in delays in getting products to market. Furthermore, the departmentalized contribution to a product leads to certain inefficiencies. Inefficiencies arise because each group is involved in trying to interpret and implement the conceived raw idea as part of their development process. Yet another problem in the industry is the propagation of errors. A single interpretation error by one department is passed on and acted upon by subsequent departments in the development line. An even further problem that exists with current product cycles is that multiple versions of the product or product information have to be developed and disseminated in order to accommodate the diverse competency of the recipients.

Current business models that utilize the Web tend to increase the number of distribution channels and audiences, thus contributing to the previously discussed problem of disparate representations of carrier products. For example, aggregators, vortals and portals have made considerable efforts to distribute the products of insurance carriers to various audiences. The majority of these distribution channels receive product information from various ‘republishers’ such as insurance rating vendors. Unfortunately, this republication of complex rule-based insurance products opens the door to disparate end results in addition to the other problems that were previously discussed.

An illustration of the flow and steps involved with current product distribution models can be found in FIG. 5. In this illustration, the focus is on the dissemination of one product, however, the same model is equally applicable and is in fact compounded as the number of products to be distributed increases. There is a significant amplification of the current distribution inadequacies because of the multiple versions or reproductions of a product that are needed to accommodate the various intended audiences. Within the current distribution model, a product 111 is generated by a carrier and then disseminated to multiple distributors 408-412, such as the vortals and portals. Each distributor 408-412 engages in some form of a translation 502a-502c of the received product in order to aide the intended distributor's audience in understanding the product. As a result, each translation 502a-502c could be different and could involve a process wherein an agent 412 is explaining the intricacies of the product to a potential client or a process wherein a consumer 410 is interpreting the information that he has received. In either case, the end result is that essentially different products 504-508 are created. This creates a problem of products 504-508, which are inconsistent with the original product 111 that originated from the carrier. One possible effect of this problem is that a consumer shopping through different distributors could receive quotes that are significantly different in price even though the quotes are for the same policy, from a single insurance company. This creates problems of customer satisfaction and credibility for the insurance carrier. Companies need to be able to ensure the accuracy and expediency of the distributed information to each specific audience.

Accordingly, there exists a need for a method that targets a distributed environment to enable the consolidation, distribution and execution of business rules. The present invention provides a method and system that enables a business to consolidate the development effort of business rule products, as well as enabling a method for distributing the completed product to the target audience in a context sensitive manner. Furthermore, the method of the current invention provides a system that enables companies to utilize one consistent and reliable source for all of the disparate uses of their information and products.

### SUMMARY OF THE INVENTION

It is an object of the present invention to provide centralized and consolidated development of rule based products.

It is a further object of this invention to provide a method for consistently distributing rule based products from a single central information source.

It is an even further object of this invention to provide a method for the execution of business rules in a user sensitive manner with the appropriate level of context presentation.

Additional objects, advantages, and novel features of the invention will be set forth in part in the description which follows, and in part will become apparent to those skilled in the practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The present invention is described in detail below with reference to the attached drawing figures, wherein:

FIG. 1 is an exemplary block diagram illustrating some component units for the practice of the present inventive method of product deployment.

FIG. 2 is a block diagram illustrating a method of the present invention for the development of rule based products within the insurance industry;

FIG. 3 is a block diagram illustrating a method of the present invention for the deployment of rule based products;

FIG. 4 is a block diagram illustrating the lineal product cycle of a typical insurance product.

FIG. 5 is a block diagram illustrating the traditional hierarchical delivery of business rule based products within the insurance industry.

### DETAILED DESCRIPTION OF THE INVENTION

The present invention is directed to a system and method for providing distributed and consistent definition, development and deployment of rule based products throughout a distributed network environment. The particular embodiments described herein are intended in all respects to be illustrative rather than restrictive. Alternate embodiments will become apparent to those skilled in the art to which the present invention pertains without departing from its scope. While the embodiments described herein are directed to the insurance industry, it is contemplated that the present invention is applicable beyond the insurance industry to other rule-based industries such as financial institutions. The current invention employs computing systems for the implementation of the business method. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, and distributed computing environments that include any of the above systems or devices. The invention may also be practiced in distributed computing environments where tasks are performed by remote processing devices that are linked through a communications network. In a distributed computing environment, program modules may be located in both local and remote computer storage media including memory storage devices.

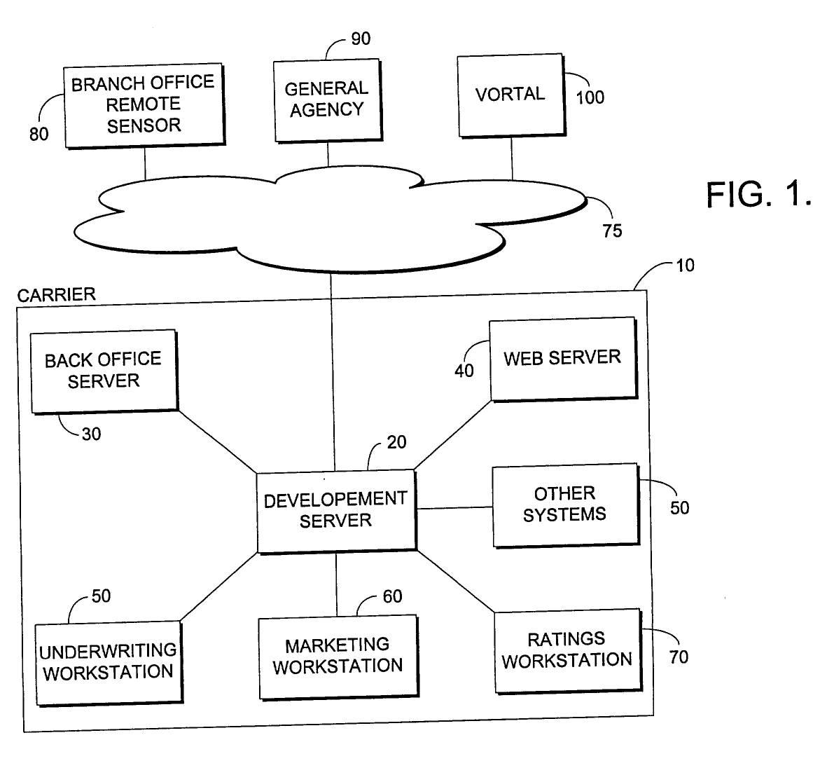

FIG. 1 illustrates an exemplary distributed network environment in which the present invention can be implemented. The inventive method should not be interpreted as having any dependency or requirement relating to any one or combination of components illustrated in the exemplary process. An insurance carrier, generally designated as 10, may have multiple in house computers 50, 60, 70 servers 20, 30, 40 and other systems 105 that are connected to external systems on a WAN, Internet or other distributed networking environment. In addition, the insurance carrier may also be logically connected to other remote systems such, as office locations 80, insurance agents 90 and Web vortals 100. The remote computers 80, 90, 100 and computing systems 20-70 may be a personal computer, a server, a router, a network PC, a peer device or other common network node. The logical connections depicted in FIG. 1 include a local area network (LAN) and a wide area network (WAN), but may also include other methods of connecting computing devices. Such networking environments are commonplace in offices, enterprise-wide computer networks, intranets and the Internet. It will be appreciated by those in the art that the shown network connections are exemplary and that other means of establishing a communications link between the computers may be used.

The method of the present invention allows a carrier to leverage connectivity to external entities as well as connectivity within the carrier's organization. Through connectivity, the method of the present invention provides a multi-user environment that enables a collaborative development effort, rather than the traditional method of a lineal product development process. Within the current invention, there is the ability for different functional areas to simultaneously work on their specific portions of a product. Underwriters, actuaries, marketing staff and programmers can all work together on one cohesive manuscript. A manuscript is document with an industry standard syntax that includes integrated information and intelligence, defines a product, and can be transported across a network between disparate or proprietary systems. An example of such a document includes an XML (Extensible Markup Language) document.

XML describes a class of data objects within XML documents, which are used to format data on the World Wide Web. XML is a subset of SGML, which is the Standard Generalized Markup Language. XML documents are made up of storage units called entities which contain either parsed or unparsed data. Parsed data is made up of characters, some of which are traditional character data and some of which are markup data. Markup encodes a description of the document's storage layout and the logical structure. XML provides a mechanism to impose constraints on the storage layout and the logical structure of information.

In general, the nature and type of information contained or defined within a manuscript will vary both by product and industry. In the case of an insurance carrier, a product manuscript would include integrated insurance rates, rules, coverage and product information. These components of the manuscript must be specifically defined within the syntax of the document. In an embodiment of the present invention, an authoring tool is provided to facilitate the definition, development and deployment of product manuscripts. The authoring tool provides a point-and-click multi-user Rapid Application Development (RAD) environment that enables multiple contributors of different skill sets to engage in the development of a product. The authoring tool provides functionality that is common to most software development tools, such as version control, security, and editing functions. In addition, the authoring tool facilitates the collaboration of several people in the simultaneous development of the product.

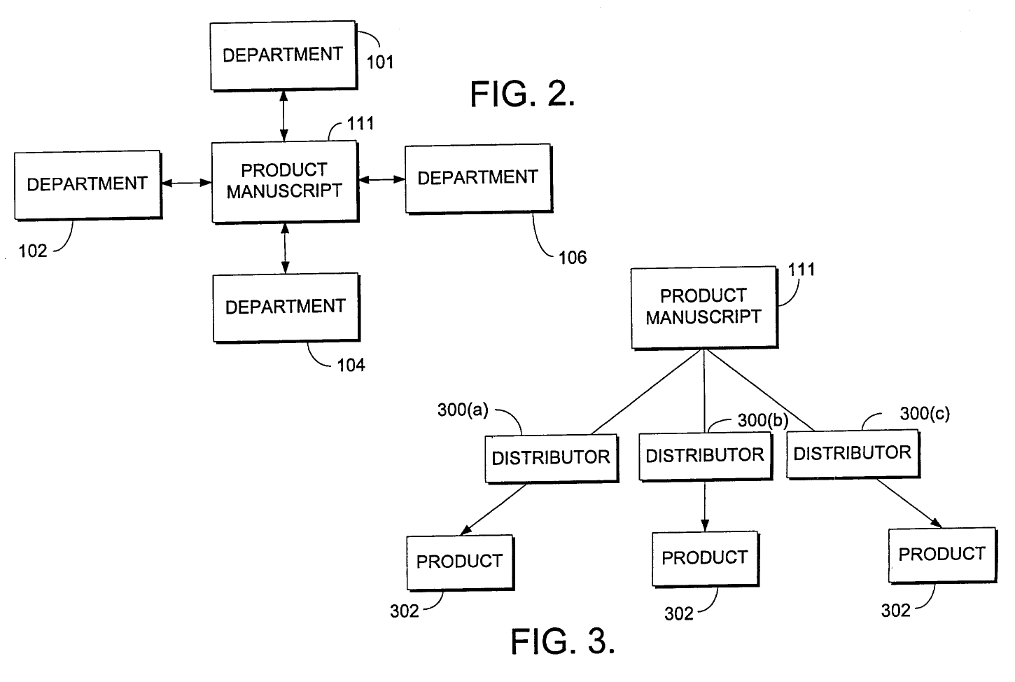

A block diagram shown in FIG. 2 illustrates the concept of collaborative and simultaneous development discussed earlier. Each department 101-106 is able to simultaneously access a product manuscript 111. While security features provide some limitation on access, the only true limitation to the number of people that can be involved in the development process is a function of the distributed network of the insurance carrier. More importantly, this collaborative and simultaneous development concept prevents users from having to contend with varying document formats throughout the product development cycle, because the manuscript and the authoring tool provide a consistent environment for development and access. One of the novel features of this inventive system and method lies in the fact that the authoring tool that creates the manuscript is also capable of directing the deployment of the manuscript. Upon completion of the development process, the manuscript embodies the final product. Attention then shifts to the issues relating to distribution of the final product.

In FIG. 3, a block diagram illustrates the distribution of a product manuscript 111. The method of the present invention facilitates a product distribution model that enables a single consistent manuscript 111 to be distributed to or obtained by multiple distributors 300. The distributors are then able to provide individual yet consistent products 302 for consumption. It should be noted that the product 302 is consistent with regard to its concept rather than just appearance. This is because the present invention allows a single version of a product to be disseminated with a context and appearance that can be adaptively defined within the product. Accordingly, the product can be made to vary according to the sophistication level of multiple audiences. This adaptive functionality is enabled by a server that can host and interpret manuscripts for use on a distributed network. In an embodiment of the present invention, a turnkey server product that is manageable, scalable, flexible and secure is provided to handle requests for information. The information that is sought from the server is embedded or referenced within a product manuscript that is deployed onto the server at the conclusion of the development cycle. This centrally located product manuscript can then be utilized by both local and remote systems with either an information push or pull methodology. In other words, the information could be sent (push) from the central location to other systems, or the information could be requested (pulled) from the server at the bequest of the other systems. It should be noted that the ability to have the manuscript and its referenced information reside on multiple systems is within the scope of this invention.

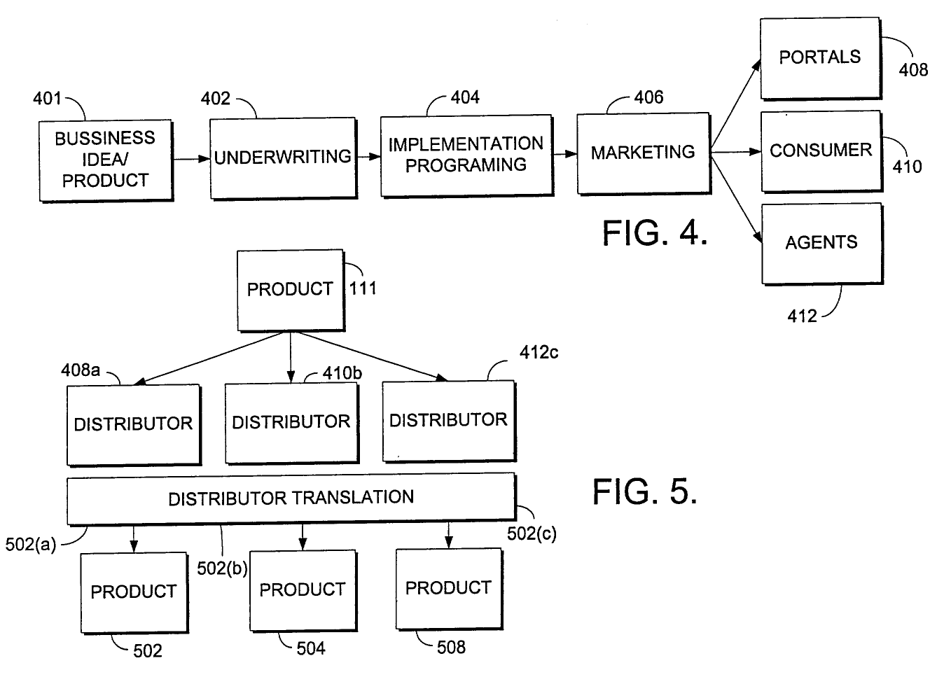

The inventive method should not be interpreted as having any dependency or requirement relating to any one or combination of components illustrated in the exemplary process. Alternative embodiments of the present invention will become apparent to those skilled in the art to which it pertains upon review of the specification, including the drawing figures. The various systems and methods shown in FIGS. 1-5 and described in the specification are merely exemplary of those suitable for use in connection with the present invention. Accordingly, the scope of the present invention is defined by the appended claims rather than the foregoing description.

We claim:

1. A method for the development and deployment of a rule based product comprising:
creating a manuscript to define the product;
incorporating into said manuscript deployment and execution instructions;
providing a central repository for said manuscript wherein one or more individuals on a distributed network can collaboratively develop said manuscript simultaneously; and
providing said manuscript to one or more users on a distributed network from said central repository;
wherein said manuscript provides a consistent product concept to said one or more users.

2. The method of claim 1 wherein said manuscript contains tables, rules, screen information and textual information.

3. The method of claim 1 wherein said manuscript is an XML document.

4. The method of claim 1 wherein said incorporated deployment and execution instructions enable information contained within said manuscript to be depicted in a plurality of formats.

5. The method of claim 1 wherein said providing of manuscripts includes hosting the manuscripts on one or more servers and handling requests from client systems.

6. The method of claim 1 further comprising the execution of said manuscript by one or more computing systems on a distributed network.

7. A system for the development and deployment of a rule based product comprising:
means for creating a manuscript that defines the rule based product;
means for incorporating instructions for deployment and execution into said manuscript;
a central repository for said manuscript wherein said manuscript is simultaneously accessible on a distributed network; and
means for deploying said manuscript.

8. The system of claim 7 wherein said manuscript contains tables, rules, screen information and textual information.

9. The system of claim 7 wherein said manuscript is an XML document.

10. The system of claim 7 wherein said incorporated deployment and execution instructions enable information contained within said manuscript to be depicted in a plurality of formats.

11. A method for the development and deployment of a rule based product comprising:
providing a manuscript to encapsulate rules, text, information and the appearance of a product;
providing a central repository for said manuscript;
providing simultaneous access to said manuscript within said central repository to enable collaborative development of said manuscript; and
providing means for deploying said manuscript to one or more destinations on a distributed network whereby said product is conveyed with a context and presentation selectively modified to suit the expertise of the recipient.

12. A method in a computing system for creating and maintaining a manuscript, wherein said manuscript is located such that one or more users can simultaneously access said manuscript.

13. A method in a computing system for defining and implementing the deployment of a manuscript on a distributed network.

14. A method in a computing system for providing information on a rule based product by creating an intelligent document that incorporates rules, text and presentation information.

15. A computer readable medium having computer executable instructions for performing the method recited in claim 10.

16. A computing system having a memory and a processor, said processor being operable to execute the instructions for the method recited in claim 10.

17. A computer readable medium having computer executable instructions for performing the method recited in claim 1.

18. A computing system having a memory and a processor, said processor being operable to execute the instructions for the method recited in claim 1.
